(19) United States
(12) Patent Application Publication
(10) Pub. No.: US 2017/0162092 A1
(43) Pub. Date: Jun. 8, 2017

(54) POWER SUPPLY, DISPLAY DEVICE AND DRIVING METHOD OF THE SAME

(71) Applicant: SAMSUNG DISPLAY CO., LTD., Yongin-si (KR)

(72) Inventors: Dong In KIM, Yongin-si (KR); Min Woo KIM, Yongin-si (KR); On Sik CHOI, Yongin-si (KR)

(21) Appl. No.: 15/258,259

(22) Filed: Sep. 7, 2016

(30) Foreign Application Priority Data
Dec. 2, 2015 (KR) 10-2015-0170693

(51) Int. Cl. G09G 3/00

(52) U.S. Cl. CPC G09G 3/006; G09G 2300/0426; G09G 2310/08; G09G 2320/041; G09G 2310/0291; G09G 2330/021; G09G 2330/12

(57) ABSTRACT

A display device includes at least one device performing a display function and a power supply unit which supplies power to the device and determines whether a malfunction of the device occurred, stops supplying power to the device during a preset power supply stop period when a malfunction of the device occurred and resumes supplying power to the device after the preset power supply stop period.

This application claims priority to Korean Patent Application No. 10-2015-0170693, filed on Dec. 2, 2015, and all the benefits accruing therefrom under 35 U.S.C. §119, the content of which in its entirety is herein incorporated by reference.

### BACKGROUND

1. Field

Exemplary embodiments relate to a power supply unit, a display device including the same and a method for driving the same.

2. Description of the Related Art

A display device is included in widely used electronic devices such as computer monitors, televisions, mobile phones, etc. Here, the display device which displays images using digital data generally includes a cathode ray tube display, a liquid crystal display, a plasma display panel (“PDP”), an organic light emitting display device, etc. As a resolution (e.g., high-definition) and a size of the display device increase, the display device transfers increased amount of data, and the transfer speed of data increases.

### SUMMARY

A display device is vulnerable to electrical stress such as electro-static discharge (“ESD”) and electrical over stress (“EOS”) and the display device may likely malfunction when electrical stress is applied.

In an exemplary embodiment, a display device may include at least one device performing a display function and a power supply unit supplying power to the device. The power supply unit may determine whether a malfunction of the device occurred, and stop supplying power to the device during a preset power supply stop period when a malfunction of the device occurred and resume supplying power to the device after the preset power supply stop period.

In an exemplary embodiment, the power supply unit, after resuming supplying power to the device, may determine whether the malfunction of the device is overcome, and stop supplying power to the device again during the preset power supply stop period when the malfunction of the device is not overcome.

In an exemplary embodiment, the power supply unit may increase a counter value by 1, and stop supplying power to the device during the preset power supply stop period when the counter value is not greater than a preset critical counter value.

In an exemplary embodiment, when the counter value is greater than the critical counter value, the power supply unit may shut down supplying power to the device and set the counter value to 0.

In an exemplary embodiment, the power supply unit may receive information showing that a malfunction occurred from the device.

In an exemplary embodiment, the counter value may be set according to a type of the device.

In an exemplary embodiment, a length of the power supply stop period may be set according to a type of the device.

In an exemplary embodiment, in an exemplary embodiment, a method for driving a display device may include determining whether a malfunction of at least one device coupled to a power supply unit occurred, stopping supplying power to the device during a preset power supply stop period when a malfunction of the device occurred and resuming supplying power to the device after the preset power supply stop period.

In an exemplary embodiment, the method may further include determining whether the malfunction of the device is overcome after the resuming of supplying power to the device and stopping again supplying power to the device during the preset power supply stop period when the malfunction of the device is not overcome.

In an exemplary embodiment, the stopping of supplying power may include increasing a counter value by 1 and stopping supplying power to the device during the preset power supply stop period when the counter value is not greater than a preset critical counter value.

In an exemplary embodiment, the stopping of supplying power may include shutting down supplying power to the device when the counter value is greater than the critical counter value and setting the counter value to 0.

In an exemplary embodiment, the determining of whether the malfunction occurred may include receiving information showing a malfunction occurred from the device.

In an exemplary embodiment, the method may further include setting the critical counter value.

In an exemplary embodiment, the method may further include setting a length of the power supply stop period.

In an exemplary embodiment, in an exemplary embodiment, a power supply unit may include a voltage generator generating a voltage needed for at least one device coupled to a power supply unit and a power supply controller determining whether a malfunction of the device occurred, and stopping supplying power to the device during a preset power supply stop period when the malfunction of the device occurred and resume supplying power to the device after the preset power supply stop period.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this invention will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 illustrates an exemplary embodiment of an electrical impact occurring on a display device according to the invention.

FIG. 2 illustrates an exemplary embodiment of a power supply controller and a driving controller according to the invention.

FIGS. 3A and 3B illustrate an example of a recovery operation when an electrical impact has occurred.

FIG. 4 illustrates an exemplary embodiment of a flow diagram of a method for preventing electrical impact of a power supply unit according to the invention.

FIG. 5 illustrates an exemplary embodiment of a recovery operation when an electrical impact has occurred on a display device according to the invention.

FIG. 6 illustrates another exemplary embodiment of a recovery operation when an electrical impact has occurred on a display device according to the invention.

FIGS. 7A and 7B illustrate an exemplary embodiment of a method for resetting power according to the invention.

FIGS. 8A and 8B illustrate another exemplary embodiment of a method for resetting power according to the invention.

FIG. 9 illustrates an exemplary embodiment of components of a display device according to the invention.

FIG. 10 illustrates another exemplary embodiment of a recovery operation when an electrical impact has occurred on a display device according to the invention.

FIGS. 11A and 11B illustrate another exemplary embodiment of a recovery operation when an electrical impact has occurred on a display device according to the invention.

### DETAILED DESCRIPTION

In the following detailed description, only certain exemplary embodiments of the invention have been shown and described, simply by way of illustration. As those skilled in the art would realize, the described embodiments may be modified in various different ways, all without departing from the spirit or scope of the invention. Accordingly, the drawings and description are to be regarded as illustrative in nature and not restrictive. In addition, it will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section, a second element, component, region, layer or section could be termed a first element, component, region, layer or section, and so forth, without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures.

It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. In an exemplary embodiment, when the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). In an exemplary embodiment, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

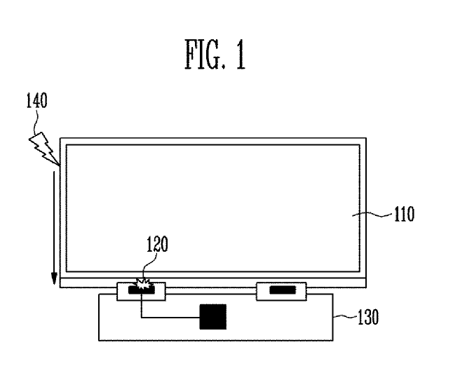

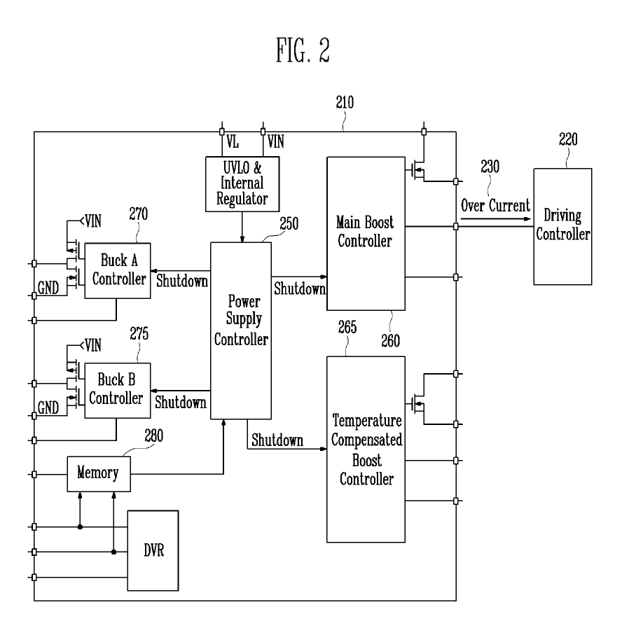

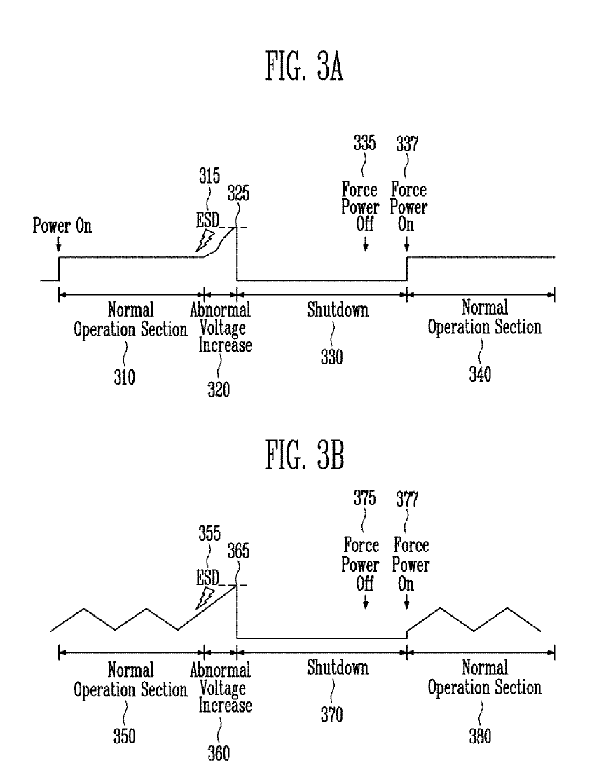

FIG. 1 illustrates an example of an electrical impact occurring on a display device according to an exemplary embodiment. FIG. 2 illustrates an example of a power supply controller and a driving controller according to an exemplary embodiment. FIG. 3 illustrates an example of a recovery operation when an electrical impact has occurred.

Referring to FIG. 1, a display device according to an exemplary embodiment may include a display unit 110, a driving controller 120 controlling driving of the display unit 110 and a power supply unit 130 supplying power to the display unit 110 and the driving controller 120.

The driving controller 120 controls general operations of the display device. In an exemplary embodiment, but without limitation, the driving controller 120 may control the general operations of inputting image data in the display unit 110, for example. Although the driving controller is illustrated as one component for purposes of convenience in illustration, it is not limited thereto. In an exemplary embodiment, but without limitation thereto, though not shown, the display device may further include a timing controller, OA-Amp, a gate driver, etc., for example.

Here, electrical stress 140 may occur on the display unit 110. The electrical stress 140 may be an electro-static discharge (“ESD”), an electrical over stress (“EOS”), etc., for example. For convenience of illustration, the electrical stress may be used interchangeably herein with ESD, EOS, etc.

When an ESD occurs on a display device, it may be largely divided into a hard failure and a soft failure. A hard failure refers to a situation when physical damage occurs on a component (integrated circuits, active and/or passive devices, printed circuit boards, etc.) due to ESD and the component is unable to recover even though there is a restart. A soft failure refers to a situation when damage to logic occurs, not physical damage, on a display device, abnormal display continues after the occurrence of the ESD, and it can be restored to normal display after a restart.

Referring to FIG. 1 again, when an ESD 140 occurs on the display unit 110, there may be a malfunction of the driving controller 120. Accordingly, an over-current may be generated from the power supply unit 130 to the driving controller 120. The power supply unit 130 may sense the occurrence of the over-current, and the power supply unit 130 may shut down supplying of power or power supply. The power supply unit 130 may shut down the power supply, and thus the components of the display device may be prevented from being physically damaged by the ESD 140, i.e., from having a hard failure.

The shut down of the power supply will be described with reference to FIGS. 2 and 3.

Referring to FIG. 2, a power supply unit 210 according to an exemplary embodiment may include a power supply controller 250, boost controllers 260 and 265, buck controllers 270 and 275 and a memory 280. The power supply unit 210 may further include an under-voltage-lockout (“UVLO”), an internal regulator, a discharge voltage regulator (“DVR”), etc. The boost controllers 260 and 265 may, according to an exemplary embodiment, include a main boost controller 260, a temperature compensated boost controller 265, etc. The buck controllers 270 and 275 may include a plurality of buck controllers, a first buck controller 270, a second buck controller 275, etc. The power supply controller 250 may perform operations controlling general operations of the power supply unit 210. In an exemplary embodiment, the power supply controller 250 may operate by a control logic and inter-integrated (“I²C”) interface. In an exemplary embodiment, but without limitation thereto, as described below, when over-voltage or over-current, etc., is formed on the boost controllers 260 and 265, the buck controllers 270 and 275, etc., power supply to the corresponding boost controllers 260 and 265, the corresponding buck controllers 270 and 275, etc., may be shut down, for example. Information about a critical current or a critical voltage, etc., for determining over-current or over-voltage, etc., information for performing operations of the power supply controller 250, etc., may be stored in the memory 280. In an exemplary embodiment, the memory 280 may be an electrically erasable programmable read-only memory (“EEPROM”) according to an exemplary embodiment, for example. In the description provided below, a boost converter includes the boost controllers 260 and 265 and a switch controlled by the boost controllers 260 and 265, and a buck converter includes the buck controllers 270 and 275 and a switch controlled by the buck controllers 270 and 275.

The power supply unit 210 may receive input power VIN, receive internal operation power VL of the power supply unit 210, and supply preset voltages to devices coupled to the power supply unit 210. To this end, the boost controllers 260 and 265 and the buck controllers 270 and 275 may convert using the input power VIN into a necessary voltage and supply it to the devices that need it. Here, the boost controllers 260 and 265 and the buck controllers 270 and 275 may be also referred to as voltage generators 260, 265, 270 and 275 for convenience in illustration.

An ESD may occur on a display device (not shown) that includes the power supply unit 210. Here, a malfunction due to the ESD may occur in a device (e.g., a driving controller 220, a timing controller (not shown), an operational amplifier (“OP-Amp”) (not shown), etc., which receives a voltage from the power supply unit 210. In an exemplary embodiment, but without limitation thereto, an over-current 230 may flow in the driving controller 220 when there is an occurrence of ESD as shown in FIG. 2, for example. Here, the power supply unit 210 may determine whether the over-current 230 flows in the driving controller 220 by determining whether the current that flows to the driving controller 220 is greater than a preset current. When the over-current 230 is determined to flow in the driving controller 220, the power supply unit 210 may shut down power supply to the main boost controller 260 which supplies a voltage to the driving controller 220, thereby preventing a hard failure.

Although not shown, when the device which receives power supply through the buck controllers 270 and 275 or the temperature compensated boost controller 265 has a malfunction due to the ESD, for example, but without limitation thereto when an over-current flows, the power supply controller 250 of the power supply unit 210 may shut down power supply to the buck controllers 270 and 275 or the temperature compensated boost controller 265 to which a corresponding device is coupled, thereby preventing a hard failure.

In an exemplary embodiment, a method for shutting down power for the power supply unit in order to prevent a hard failure of a component due to ESD may include over-current protection (“OCP”), over-voltage protection (“OVP”), under-voltage protection (“UVP”), diode open protection (“DOP”), thermal shutdown (“TS”), etc., for example.

The OCP shuts down power supply to a corresponding buck converter and/or a corresponding boost converter, etc., when the power supply controller 250 senses that an output current of the buck converter and/or the boost converter, etc., abnormally increases.

The OVP shuts down power supply to a corresponding input power voltage Vin and/or a corresponding buck converter and/or a corresponding boost converter, etc., when the power supply controller senses that an output voltage of the input power voltage Vin and/or a buck converter and/or a boost converter, etc., increases higher than a preset voltage.

The UVP shuts down power supply to a corresponding buck converter and/or a corresponding boost converter, etc., when the power supply controller senses that an output voltage of the buck converter and/or the boost converter, etc., falls below a preset voltage.

The DOP shuts down power supply to a corresponding buck converter and/or a corresponding boost converter when the power supply controller 250 senses opening of a diode of the buck converter and/or the boost converter.

The TS shuts down power supply to a corresponding device when the power supply controller 250 senses that a temperature of the certain device is of or becomes higher than a preset temperature.

Referring to FIGS. 3A and 3B, FIG. 3A shows an example of an OVP operation, and FIG. 3B shows an example of an OCP operation.

Referring to FIG. 3A, a voltage may be supplied to a device (a driving controller will be used as an example) which receives a voltage from a power supply unit in a normal operation section 310. Here, an ESD 315 may occur during the normal operation section 310. Accordingly, a voltage that is supplied to a driving controller may abnormally increase as shown during an abnormal voltage increase section 320. When the voltage is increased as much as a preset critical voltage 325, the power supply unit may sense the increase. When the power supply unit senses that the voltage supplied to the driving controller is of or greater than the critical voltage 325, the power supply unit may shut down the power supply to the corresponding driving controller. Thereafter, in a state 330 in which power supply is shut down, when a user, etc., force-shuts down (335) the power of the display device and force-turns on (337) the display device, the display device may return to a normal operation section 340.

Also, referring to FIG. 3B, a current may be supplied to a device (e.g., a driving controller) which receives a voltage from the power supply unit in a normal operation section 350. Here, an ESD 355 may occur during the normal operation section 350. Accordingly, a current that flows to a driving controller may abnormally increase as shown during an abnormal voltage increase section 360. When the current is increased as much as a preset critical current 365, the power supply unit may sense the increase. When the power supply unit senses that the current flowing to the driving controller is of or greater than the critical current 365, the power supply unit may shut down the power supply to the corresponding driving controller. Thereafter, in a state 370 in which power supply is shut down, when a user, etc., force-shuts down 375 the power of the display device and force-turns on 377 the display device, the display device may return to a normal operation section 380.

As such, the power supply unit may shut down power supply to a corresponding device when a supply voltage or a supply current to the certain device increases to a preset critical voltage 325 or a critical current 365 or greater. When the power supply unit shuts down the power supply, a hard failure of the display device may be prevented. By force-turning off and force-turning on the display device again, the display device may normally operate. However, in the event of a method for shutting down power supply as such, although physical damage on the corresponding device (i.e., the driving controller in the above example) of the display device may be prevented, it still may give rise to an ESD soft failure. Therefore, not only a method for preventing a physical hard failure, but also a method for preventing a soft failure is needed.

FIG. 4 illustrates an example of a flow diagram of a method for preventing electrical impact of a power supply unit according to an exemplary embodiment.

A power supply unit may determine whether electrical stress, e.g., an ESD, occurred on a display device. That is, the power supply unit may determine whether a malfunction occurred in a certain device among display devices due to ESD. Details thereof are provided below.

In operation 410, the power supply unit may determine whether an input power voltage Vin and/or an output voltage of a buck converter and/or a boost converter, etc., abnormally increases. That is, the power supply unit may determine whether an over-voltage is supplied to a device which receives a voltage from the power supply unit, e.g., a driving controller, a timing controller, an OP-Amp, etc. Here, the power supply unit may determine whether the over-voltage is supplied by comparing a voltage that is supplied to a device coupled to the power supply unit with a preset critical voltage.

In operation 410, when it is determined that the over-voltage is not supplied, in operation 415, the power supply unit may determine whether an over-current flows to a device which receives a voltage from the power supply unit as an output current of a buck converter and/or a boost converter, etc., abnormally increases. Here, the power supply unit may determine whether the over-current flows to the device by comparing a current which flows to a device coupled to the power supply unit with a preset critical current.

In operation 415, when it is determined that the over-current does not flow to the devices coupled to the power supply unit, in operation 420, the power supply unit may determine whether a diode of a buck converter and/or a boost converter is open.

In operation 420, when it is determined that the diode of the buck converter and/or the boost converter is not open, in operation 425, the power supply unit may determine whether the output voltage of the buck converter and/or the boost converter, etc., abnormally drops. That is, the power supply unit may determine whether an under-voltage is supplied to a device which receives a voltage from the power supply unit. Here, the power supply unit may determine whether an under-voltage is supplied by comparing a voltage that is supplied to the device coupled to the power supply unit with a preset critical under-voltage.

In operation 420, when it is determined that no under-voltage is supplied, in operation 430, the power supply unit may determine whether a temperature of a certain device of the display device is higher than a preset critical temperature. That is, the power supply unit may determine whether the temperature of the device which receives the voltage from the power supply unit is of the preset critical temperature or greater.

In operation 430, when it is determined that there is no device of the display device which has a temperature that is of the critical temperature or greater, in operation 440, the power supply unit may perform normal operations. That is, the power supply unit may supply power normally to the devices coupled to the power supply unit.

A memory of the power supply unit may store information, etc., for the power supply unit to perform operations to determine whether an ESD occurred in the display device. In an exemplary embodiment, but without limitation thereto, in operations 410 to 430, a critical voltage, a critical current, a critical under-voltage, a critical temperature, etc., for the power supply unit to make determination may be stored in the memory of the power supply unit, for example.

Also, the order of the operations 410 to 430 may be changed depending on an exemplary embodiment. In an exemplary embodiment, but without limitation thereto, the power supply unit may determine whether the output current of the buck converter and/or the boost converter, etc., is of the critical current or greater (operation 415), for example. When it is not, the power supply unit may determine whether an input power voltage Vin and/or an output voltage of the buck converter and/or the boost converter, etc., is of the critical voltage or greater (operation 410).

Depending on an exemplary embodiment, in order for the power supply unit to determine whether an ESD occurred in the display device, not all of operations 410 to 430 need to be performed. Depending on an exemplary embodiment, only a portion of the operations may be performed. In an exemplary embodiment, but without limitation thereto, the power supply unit may perform operations 410, 415 and 425 to determine whether the ESD occurred in the display device, for example.

In any one of operation 410, 415, 420, 425 or 430, the power supply unit may determine that the ESD occurred. Here, in operation 490, the power supply unit may reset power.

A reset operation of the power supply unit refers to an operation in which power supply to the device of the display device where a malfunction has occurred due to ESD is stopped momentarily and is restored. This is distinguishable from the shutdown of the power supply unit. That is, the shutdown is when the power supply unit shuts down power supply to a corresponding device, and a user, etc., must force-turn off the power supply unit and then turn on in order to achieve power supply to the corresponding device. However, the reset operation is when the power supply unit stops supplying power to the corresponding device momentarily and after a preset stop period, power supply is resumed to the corresponding device automatically. The stop period is not fixed but the value may be variably set depending on the setting. Details relating to the reset operation will be provided below.

According to an exemplary embodiment, the power supply unit may increase a counter value by 1 in operation 450 before performing the reset operation in operation 490, for example. In an exemplary embodiment, the counter value may be stored in the memory of the power supply unit, and an initial value of the counter value may be set to 0, for example. The counter value is for setting a number of times the reset operation of the power supply unit is performed. That is, the counter value is for the power supply unit to perform the reset operations only for a preset number of reset operations due to the occurrence of ESD. This is because since the reset operations may act as a stress on the devices of the display device, the number must be limited.

In operation 460, the power supply unit may determine whether the counter value is greater than a preset critical counter value. In the drawings, the critical counter value is set to 3, for example. However, it is not limited thereto. In an exemplary embodiment, but without limitation thereto, the critical counter value may be set to 2 or below or 4 or greater, for example. Also, depending on an exemplary embodiment, the critical counter value may be variably set by a user's setting, etc., and the critical counter value may be stored in the memory of the power supply unit.

In operation 460, when the counter value is not greater than the preset critical counter value, the power supply unit may perform the reset operation in operation 490.

In operation 490, after the reset operation is performed, the power supply unit may determine whether the malfunction of the device where malfunction occurred due to ESD is overcome. To this end, the power supply unit may return to operation 410 and determine again when a malfunction due to ESD occurred in the display device.

When it is determined that the counter value is greater than the preset critical counter value in operation 460, the power supply unit may shut down power supply to the corresponding device in operation 470. That is, when the malfunction due to ESD is not overcome even though the power supply unit performed the reset operation for a preset number of times of reset, physical damage of the corresponding device, i.e., a hard failure may occur, and in order to prevent the hard failure, the power supply unit may shut down the power supply.

The power supply unit may reset the counter value to 0 in operation 480 after it shuts down the power supply. That is, the power supply unit may shut down power supply to a device where a malfunction occurred due to ESD.

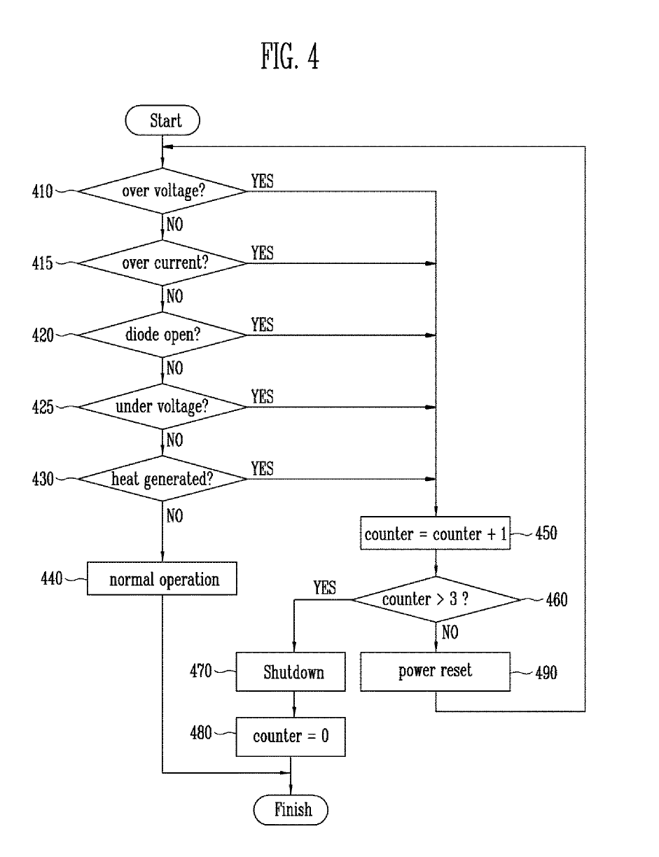

FIG. 5 illustrates an example of a recovery operation when an electrical impact has occurred on a display device according to an exemplary embodiment.

Referring to FIG. 5, a voltage may be supplied to a device (a driving controller will be used as an example) which receives a voltage from the power supply unit in a normal operation section 510. Here, an ESD 515 may occur during the normal operation section 510. Accordingly, a malfunction due to the ESD 515 may occur in the driving controller. In an exemplary embodiment, but without limitation thereto, as shown in FIG. 5, the voltage that the power supply unit supplies to the driving controller in an abnormal voltage increase section 520 may abnormally increase, for example. When the voltage is increased by a preset critical voltage 525, the power supply unit may sense this, for example. That is, the power supply unit may determine whether the voltage supplied to the driving controller is greater than the preset critical voltage 525, and thus it may determine whether a malfunction occurred in the driving controller.

Accordingly, the power supply unit may stop the power supply to the driving controller where a malfunction occurred momentarily in a first reset period reset1 and resume supplying power. That is, the power supply unit may perform the reset operation to stop the power supply to the driving controller where the malfunction occurred due to the ESD 515 momentarily and resume the power supply. Unlike shutdown, power supply to the corresponding device is not completely stopped, but power supply to the corresponding device is momentarily stopped and is resumed to the corresponding device after a preset stop period.

When it is determined that the reset operation is performed in a first reset period reset1 530 and the malfunction due to the ESD is overcome, the display device may proceed to a normal operation section 540 again.

When the malfunction due to the ESD 515 occurs, the power supply unit does not shut down power supply, but as described above, the power supply unit may perform the reset operation which stops the power supply momentarily. As a result, a soft failure for which the power of the display device in its entirety must be turned off and turned back on may be prevented.

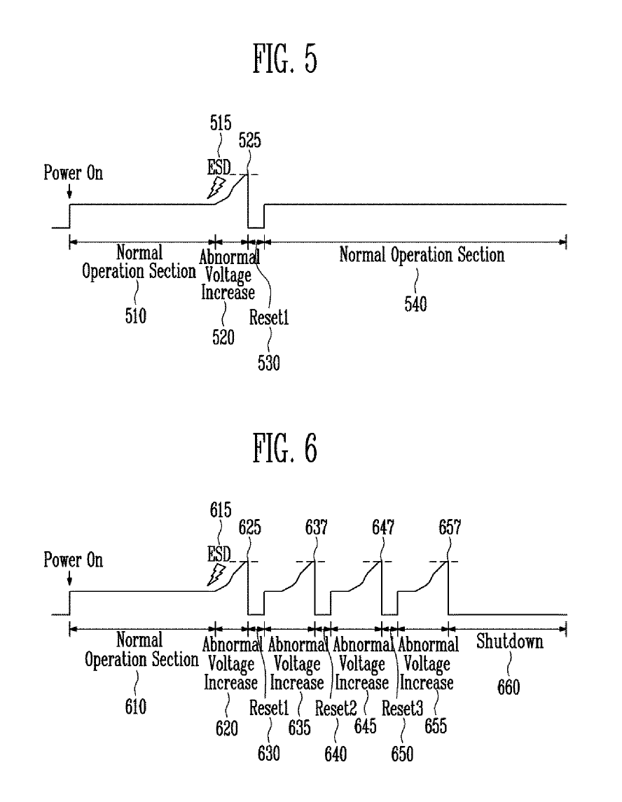

FIG. 6 illustrates another example of a recovery operation when an electrical impact has occurred on a display device according to an exemplary embodiment.

Referring to FIG. 6, in a normal operation section 610, a voltage may be supplied to a device (a driving controller will be used as an example) which receives a voltage from the power supply unit. Here, an ESD 615 may occur during the normal operation section 610. Accordingly, a malfunction due to the ESD 615 may occur in the driving controller. In an exemplary embodiment, but without limitation thereto, as shown in FIG. 6, the voltage that the power supply unit supplies to the driving controller may be abnormally increased during a first abnormal voltage increase section 620, for example. When the voltage is increased by a preset critical voltage 625, the power supply unit may sense it. That is, the power supply unit may determine whether the voltage that is supplied to the driving controller is greater than a preset critical voltage 625, and thus the power supply unit may determine when a malfunction occurred in the driving controller.

Accordingly, the power supply unit may momentarily stop power supply to the driving controller where a malfunction occurred in a first reset period reset1 630 and resume the power supply. That is, the power supply unit may momentarily stop the power supply to the driving controller where the malfunction occurred due to the ESD 615 by performing the first power reset operation reset1 and resuming the power supply.

However, although the first power reset operation reset1 is performed during the first reset period 630, the voltage that the power supply unit supplies to the driving controller may abnormally increase again as is the case in a second abnormal voltage increase section 635 since the malfunction of the driving controller is not overcome. Accordingly, when the voltage is made the same as the preset critical voltage 637, the power supply unit may again perform a second power reset operation reset2 which resets the power to the driving controller where the malfunction occurred during a second power reset period reset2 640.

Although a second power reset operation reset2 is performed during the second power reset period 640, since the malfunction of the driving controller is not overcome, the voltage that the power supply unit supplies to the driving controller may again abnormally increase as in the case of a third abnormal voltage increase section 645. Accordingly, when the voltage is made the same as the preset critical voltage 647, the power supply unit may again perform a third power reset operation reset3 which resets the power to the driving controller where the malfunction occurred.

However, even though the third power reset operation reset3 is performed during a third reset period 650, since the malfunction of the driving controller is not overcome, the voltage that the power supply unit supplies to the driving controller may abnormally increase again as in the case of a fourth abnormal voltage increase section 655. Accordingly, the voltage may be the same as a preset critical voltage 657.

Here, the power supply unit does not perform the power reset operation reset but may shut down the power supply 660. That is, even though the power supply unit performs the power reset operation reset as many times as a number of times a preset power reset is performed, when the malfunction of the device where malfunction occurred due to ESD is not been overcome, physical damage to the applicable device, that is, a hard failure may occur. Therefore, in order to prevent the hard failure from occurring, the power supply unit may shut down the power supply 660.

Although not shown, in a state 660 in which power supply is shut off, when a user, etc., force-turns off the display device, and force-turns on the display device again, the display device will enter into the normal operation section again.

In the drawings, it shows that the number of times the power reset operation reset performed is set to 3, but it is not limited thereto. That is, in the illustration, in the event the malfunction of the driving controller is detected again even though power reset operation reset is performed three times, the power supply unit shuts down the power supply. However, it can be set so that the power supply unit may shut down power supply in the event the malfunction of the driving controller is detected after power reset operation reset is performed twice or less or four times or more.

Also, even though it is not shown, when the power reset operation is performed for the preset number of times or less and the malfunction due to the ESD of the driving controller is overcome, the display device may proceed to the normal operation section again.

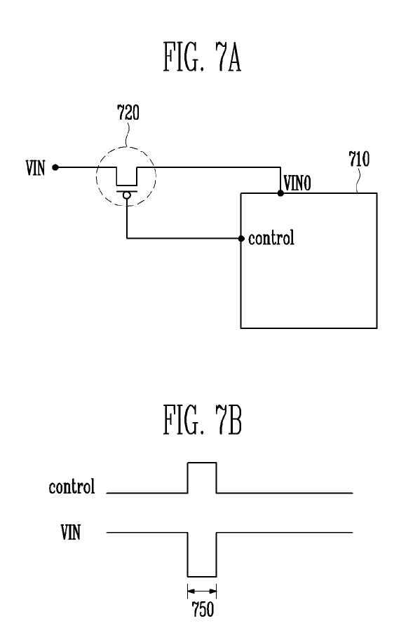

FIGS. 7A and 7B illustrate an example of a method for resetting power according to an exemplary embodiment.

Referring to FIG. 7A, an input power VIN may be supplied to a power supply unit 710 according to an exemplary embodiment. A switch 720 may be connected between the input power VIN and an input power terminal VINO of the power supply unit 710.

Depending on on/off of the switch 720, the input power VIN may be supplied to the power supply unit 710 or may be shut down. That is, when the switch 720 is on, the input power VIN may be normally supplied to the power supply unit 710. When the switch 720 is off, the input power VIN may be stopped from being supplied to the power supply unit 710.

Control of on/off of the switch 720 may be done depending on a control signal of the power supply unit 710. That is, when the power supply unit 710 determines that power reset is needed, the power supply unit 710 may send a control signal which turns off the switch 720 during a preset stop period to the switch 720 and turns the switch 720 on after the stop period. Here, when the supply of the input power VIN is shut down during a preset time for the power supply unit 710, the power supply to at least one device of the display device coupled to the power supply unit 710 may also be momentarily shut down, and thus the power reset operation may be performed.

According to an exemplary embodiment, the switch 720 may be a P-channel metal oxide semiconductor (“PMOS”) as shown in FIG. 7A, for example. Here, a first electrode of the PMOS transistor may be coupled to the input power VIN, and a second electrode may be coupled to the input power terminal VINO of the power supply unit 710. A gate electrode of the PMOS transistor may be coupled to a control signal supply terminal of the power supply unit 710.

Here, as shown in FIG. 7B, in a section 750 which receives a control signal, the PMOS transistor switch is turned off, and thus the supply of the input power VIN to the power supply unit may be shut down.

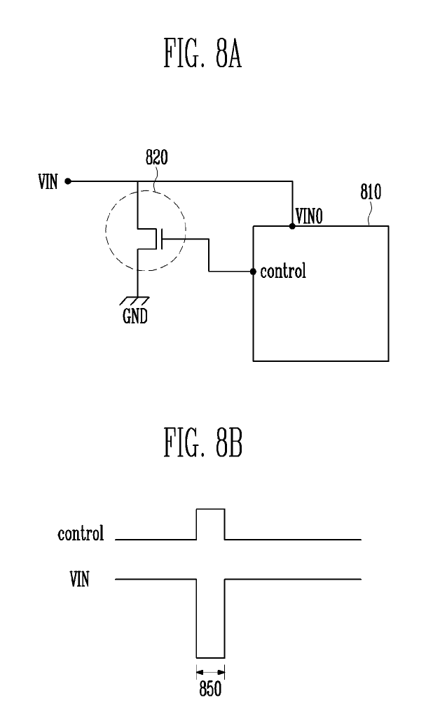

FIGS. 8A and 8B illustrate another example of a method for resetting power according to an exemplary embodiment.

Referring to FIG. 8A, input power VIN may be supplied to a power supply unit 810 according to an exemplary embodiment. An input power terminal VINO of the power supply unit 810 and a first electrode of a switch 820 may be coupled in parallel in the input power VIN. A second electrode of the switch 820 may be coupled to ground GND.

Here, depending on on/off of the switch 820, the input power VIN may be supplied to the power supply unit 810 or shut down. That is, the input power VIN may be normally supplied to the power supply unit 810 when the switch 820 is off. When the switch 820 is on, the input power VIN and the ground GND may be short-circuited, and the supply of the input power VIN to the power supply unit 810 may be stopped.

Here, controlling on/off of the switch 820 may be achieved depending on the control signal of the power supply unit 810. That is, when the power supply unit 810 determines that the power reset is needed, the power supply unit 810 may send the control signal to the switch 820 by which the switch 820 is turned on during the preset stop period and is turned off after the stop period. Here, when the supply of the input power VIN to the power supply unit 810 is shut down during the preset time, the power supply to the device of the display device coupled to the power supply unit 810 is also momentarily shut down, and thus the power reset operation reset may be performed.

According to an exemplary embodiment, the switch 820 may be an N-channel metal oxide semiconductor (“NMOS”) as shown in FIG. 8A, for example. Here, a first electrode of the NMOS transistor may be coupled to the input power VIN in parallel with an input power terminal VINO of the power supply unit 810. A second electrode of the NMOS transistor may be grounded to ground GND. A gate electrode of the NMOS transistor may be coupled to a control signal supply terminal control of the power supply unit 810.

Here, as shown in FIG. 8B, since the switch of the NMOS transistor is turned on in a section 850 to which a control signal is input, the supply of the input power VIN to the power supply unit is shut down

FIG. 9 illustrates components of a display device according to an exemplary embodiment.

Referring to FIG. 9, a display device according to an exemplary embodiment may include a power supply unit 910, a timing controller 920, a driving controller 930, an OP-amp 940, a gate driver ASG 950, etc.

Depending on the ESD, a malfunction may occur in any one of devices 920, 930, 940 or 950 of the display device. In this case, in the exemplary embodiment, it is examined that the power supply unit 910 may determine whether over-voltage, over-current, under-voltage, etc., occurred by detecting voltage, current, etc., that the power supply unit 910 supplies to each of the devices 920, 930, 940 and 950, and a method of resetting power supplied to a device where the malfunction occurred is examined.

Also, according to another exemplary embodiment, when the malfunction occurred due to the ESD in each of the devices 920, 930, 940 and 950, the device where the malfunction occurred may transmit information showing that the malfunction occurred due to the ESD to the power supply unit 910.

In an exemplary embodiment, but without limitation thereto, in the event of clock/data recovery unlock of timing controller 920, a failure of a power unit of the timing controller 920, a failure of logic of the timing controller 920, etc., the timing controller 920 may detect malfunction occurred in itself due to ESD, for example.

Accordingly, the timing controller 920 may transmit information showing that malfunction occurred in itself due to ESD to the power supply unit 910.

Also, in the event of clock/data recovery unlock of driving controller 930, a failure of a power unit of the driving controller 930, a failure of logic of the driving controller 930, etc., the driving controller 930 may detect malfunction occurred in itself due to ESD. And the driving controller 930 may transmit information showing that malfunction occurred in itself due to ESD to the power supply unit 910.

In the event of a failure of a power unit of the OP-Amp 940 due to ESD, a failure of logic of the OP-Amp 940, etc., the OP-Amp 940 may detect malfunction occurred in itself due to ESD. And the OP-Amp 940 may transmit information showing that malfunction occurred in itself due to ESD to the power supply unit 910.

The power supply unit 910 which receives information showing that malfunction occurred due to ESD from each of the devices 920, 930, 940 and 950 of the display device may reset power supply to the applicable devices depending on the information that was received.

To this end, the power supply unit 910 may allocate separate monitoring pin and may receive information showing whether malfunction occurred due to ESD in the timing controller 920, the driving controller 930, an operational amplifier OP-amp 940, a gate driver 950, etc., through the monitoring pin.

Likewise, the device where malfunction occurred (920, 930, 940 and 950) may transmit information to the power supply unit 910 in the event that other malfunction occurred inside the devices 920, 930, 940 and 950, not just the malfunction of voltage or current that is supplied to each of the devices 920, 930, 940 and 950 of the display device due to ESD. Accordingly, the power supply unit 910 may perform power reset operations to the devices 920, 930, 940 and 950 where the malfunction occurred for a preset number of times. As such, the ESD soft failure prevention function may be applied to only the power supply unit 910, thereby preventing the malfunction that occurred in other devices of the display device due to ESD.

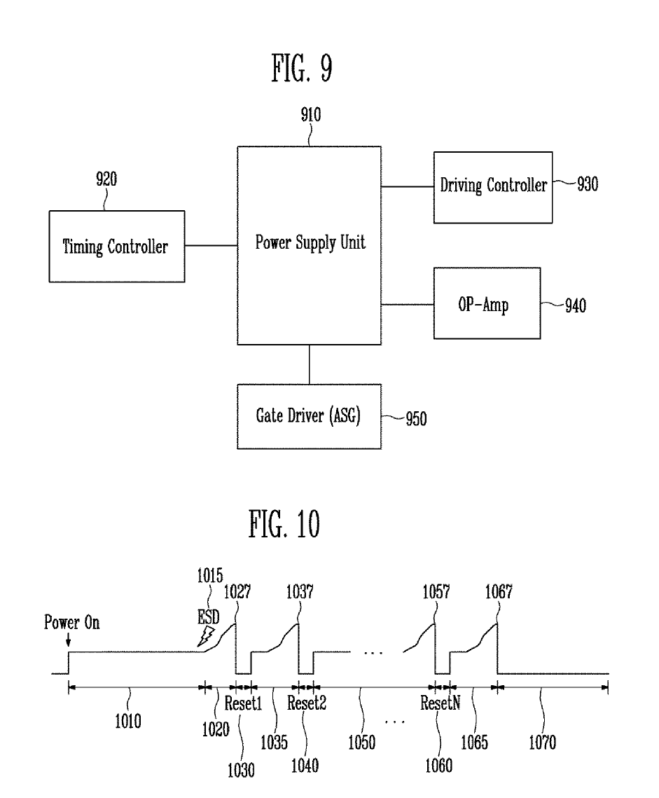

FIG. 10 illustrates another example of a recovery operation when an electrical impact has occurred on a display device according to an exemplary embodiment.

Referring to FIG. 10, a voltage may be supplied to a device (a driving controller will be used as an example) which receives a voltage from a power supply unit in a normal operation section 1010. Here, an ESD 1015 may occur during the normal operation section 1010. Accordingly, a malfunction may occur in the driving controller due to the ESD 1015. In an exemplary embodiment, but without limitation thereto, as shown in FIG. 10, the voltage that the power supply unit supplies to the driving controller may abnormally increase during a first abnormal voltage increase section 1020, for example. When the voltage increases as much as a preset critical voltage 1027, the power supply unit may sense this. That is, the power supply unit may determine whether a malfunction occurred in the driving controller by determining when the voltage that is supplied to the driving controller is greater than the preset critical voltage 1027.

Accordingly, the power supply unit may momentarily stop the power supply to the driving controller where a malfunction occurred during a first reset period reset1 1030 and resume the power supply again. That is, the power supply unit may momentarily stop the power supply to the driving controller where the malfunction occurred due to the ESD 1015 by performing the first power reset operation reset1 and resume the power supply.

However, during the first reset period 1030, even when the first power reset operation reset1 is performed, since the malfunction of the driving controller is not overcome, just as in the case of the second abnormal voltage increase section 1035, the voltage that the power supply unit supplied to the driving controller may abnormally increase. Accordingly, when the voltage is made the same as the preset critical voltage 1037, the power supply unit may perform the second power reset operation reset2 again which resets the power to the driving controller where the malfunction occurred during the second reset period reset2 1040.

And the power supply unit may perform such power reset operation reset as many as a preset number.

In an exemplary embodiment, but without limitation thereto, when the preset power reset number is N, the voltage that the power supply unit supplies to the driving controller in a (N−1)-th abnormal voltage increase section 1050 may abnormally increase and be the same as a critical voltage 1057, for example. Here, the power supply unit may perform an N-th power reset operation resetN again which resets the power to the driving controller where the malfunction occurred during an N-th reset period resetN.

However, even when the N-th power reset operation resetN is performed during an N-th reset period 1060, since the malfunction of the driving controller is not overcome, the voltage that the power supply unit supplies to the driving controller may abnormally increase again as in the case of the (N+1)-th abnormal voltage increase section 1065. Accordingly, the voltage may be made the same as the preset critical voltage 1067.

Here, the power supply unit may not perform the power reset operation reset but may shut down the power supply 1070. That is, when the power supply unit performs the power reset operation for a preset number of times but the malfunction of the device where the malfunction occurred due to the ESD is not overcome, physical destruction of the applicable device, that is, a hard failure may occur. Thus, in order to prevent this, the power supply unit may shut down the power supply 1070.

Also, though not shown, thereafter, in a state in which power supply is shut down 1070, when a user, etc., force turns off the display device and force turns back on, the display device may proceed to the normal operation section again.

As such, a power supply unit of a display device according to an exemplary embodiment may perform a power reset operation reset for a preset number of times N. Here, the number of preset power reset times may be stored in a memory of the power supply unit as a critical counter value, and the power reset number of times may vary depending on a user's setting, etc. That is, depending on input by user, etc., the number of power reset times stored in the power supply unit may vary. Also, according to an exemplary embodiment, the number of times the power reset operation reset is performed may vary for each device of the display device. In an exemplary embodiment, but without limitation thereto, when there is a malfunction occurred due to the ESD in the driving controller, the number of power reset operations reset performed is limited to 3, and when there is a malfunction that occurred due to ESD in OP-Amp, the number of power reset operations reset performed is limited to 4, for example. As such, the number of the power reset operations reset performed may be set differently for each device.

As such, the number of times the power reset operation reset is performed may be variably set considering protection of the power supply unit and operations of each device of the display device.

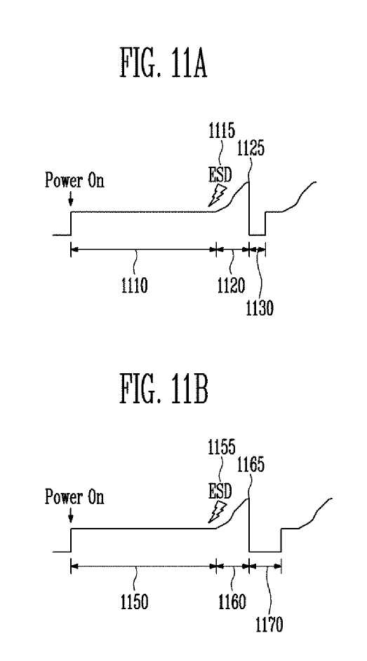

FIGS. 11A and 11B illustrate another example of a recovery operation when an electrical impact has occurred on a display device according to an exemplary embodiment.

Referring to FIG. 11A, a voltage may be supplied to a device (a driving controller will be used as an example) which receives a voltage from a power supply unit in a normal operation section 1110. Here, an ESD 1115 may occur during the normal operation section 1110. Accordingly, a malfunction due to the ESD 1115 may occur in the driving controller. In an exemplary embodiment, but without limitation thereto, a voltage that a power supply unit supplies to a driving controller in an abnormal voltage increase section 1120 may abnormally increase, for example. When the voltage is increased by a preset critical voltage 1125, the power supply unit may sense it. That is, the power supply unit may determine whether a malfunction occurred in the driving controller by determining whether the voltage that is supplied to the driving controller is greater than the preset critical voltage 1125.

Accordingly, the power supply unit may momentarily stop power supply to the driving controller where a malfunction occurred and resume supplying power in a reset period 1130. That is, the power supply unit may, by performing a power reset operation reset, momentarily stop power supply to the driving controller where a malfunction occurred due to the ESD 1115 and resume the power supply. That is, the power supply unit may momentarily stop the power supply to a device where a malfunction occurred due to the ESD 1115 and resume the power supply to the applicable device after a preset period has passed.

However, the power supply stop period may be variably set in consideration of protection of the power supply unit and the operations of each device of the display device.

Referring to FIG. 11B, a voltage may be supplied to a device (a driving controller will be used as an example) which receives a voltage from a power supply unit in a normal operation section 1150. Here, an ESD 1155 may occur during the normal operation section 1150. Accordingly, a malfunction due to an ESD 1155 may occur in the driving controller. In an exemplary embodiment, but without limitation thereto, the voltage that the power supply unit supplies to the driving controller in an abnormal voltage increase section 1160 may abnormally increase, for example. When the voltage is increased by a preset critical voltage 1165, the power supply unit may sense it. That is, the power supply unit may, by determining whether the voltage that is supplied to the driving controller is greater than the preset critical voltage 1165, determine whether a malfunction occurred in the driving controller.

Here, the power supply unit may reset power supply to the driving controller where a malfunction occurred during a reset period 1170. Here, the power supply stop period where the power supply unit stops power supply may be set longer than what is shown in FIG. 11A.

That is, as shown in FIGS. 11A and 11B, the length of the power supply stop period may be changed based on user's setting, etc. Here, the length of the power supply stop period may be stored in a memory of the power supply unit. Also, according to an exemplary embodiment, the length of the power supply stop period may be variably set for each device of the display device. In an exemplary embodiment, but without limitation thereto, the length of the power supply stop period in the event a malfunction occurred due to ESD in the driving controller and the length of the power supply stop period in the event a malfunction occurred due to ESD in an OP-Amp may be set to be different from each other, for example.

Also, though not shown, the length of the power supply stop period maybe set to increase or decrease as the number of times the power supply is stopped is increased depending on an exemplary embodiment. In an exemplary embodiment, but without limitation thereto, as shown in FIG. 10, etc., when it is necessary to perform a power reset operation for a multiple times, the length of a second power supply stop period during when a second power reset operation is performed may be set longer or shorter than the length of a first power supply stop period during when a first power reset operation is performed, for example.

As such, the length of the power supply stop period for performing power reset operation may be variably set in consideration of protection of the power supply unit and operations of each device of the display device.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the invention as set forth in the following claims.

What is claimed is:

1. A display device comprising:
at least one device; and
a power supply unit which supplies power to the at least one device,
wherein the power supply unit determines whether a malfunction of the at least one device occurred, and stops supplying power to the at least one device during a preset power supply stop period when a malfunction of the at least one device occurred and resumes supplying power to the at least one device after the preset power supply stop period.

2. The display device as claimed in claim 1, wherein the power supply unit, after resuming supplying power to the at least one device, determines whether the malfunction of the at least one device is overcome, and stops supplying power to the at least one device again during the preset power supply stop period when the malfunction of the at least one device is not overcome.

3. The display device as claimed in claim 1, wherein the power supply unit increases a counter value by 1, and stops supplying power to the at least one device during the preset power supply stop period when the counter value is not greater than a preset critical counter value.

4. The display device as claimed in claim 3, wherein, when the counter value is greater than the preset critical counter value, the power supply unit shuts down supplying power to the at least one device and sets the counter value to 0.

5. The display device as claimed in claim 1, wherein the power supply unit receives information showing that a malfunction occurred from the at least one device.

6. The display device as claimed in claim 3, wherein the counter value is set according to a type of the at least one device.

7. The display device as claimed in claim 1, wherein a length of the power supply stop period is set according to a type of the at least one device.

8. A method for driving a display device, the method comprising:
determining whether a malfunction of at least one device coupled to a power supply unit occurred;
stopping supplying power to the at least one device during a preset power supply stop period when a malfunction of the at least one device occurred; and
resuming supplying power to the at least one device after the preset power supply stop period.

9. The method as claimed in claim 8, further comprising;
determining whether the malfunction of the at least one device is overcome after the resuming of supplying power to the at least one device; and
stopping again supplying power to the at least one device during the preset power supply stop period when the malfunction of the at least one device is not overcome.

10. The method as claimed in claim 8, wherein the stopping supplying power comprises:
increasing a counter value by 1; and
stopping supplying power to the at least one device during the preset power supply stop period when the counter value is not greater than a preset critical counter value.

11. The method as claimed in claim 10, wherein the stopping supplying power comprises:
shutting down supplying power to the at least one device when the counter value is greater than the preset critical counter value; and
setting the counter value to 0.

12. The method as claimed in claim 8, wherein the determining whether the malfunction occurred comprises receiving information showing a malfunction occurred from the at least one device.

13. The method as claimed in claim 10, further comprising setting the preset critical counter value.

14. The method as claimed in claim 8, further comprising setting a length of the power supply stop period.

15. A power supply unit comprising:
a voltage generator which generates a voltage needed for at least one device coupled to a power supply unit; and
a power supply controller which determines whether a malfunction of the device occurred, and stop supplying power to the at least one device during a preset power supply stop period when the malfunction of the at least one device occurred and resume supplying power to the at least one device after the preset power supply stop period.
